(19) United States
(12) Patent Application Publication
(10) Pub. No.: US 2015/0235272 A1
(43) Pub. Date: Aug. 20, 2015

(54) MULTI-PLATFORM PROMOTIONS FOR MOBILE DEVICES

(71) Applicants: Scott HUTCHINSON, Plano, TX (US); Walter CHEN, McKinney, TX (US)

(72) Inventors: Scott HUTCHINSON, Plano, TX (US); Walter CHEN, McKinney, TX (US)

(73) Assignee: PASSBEEMEDIA, Plano, TX (US)

(21) Appl. No.: 14/461,381

(22) Filed: Aug. 16, 2014

Related U.S. Application Data
(60) Provisional application No. 61/941,550, filed on Feb. 19, 2014.

(51) Int. Cl. G06Q 30/02; H04M 3/487

(52) U.S. Cl. CPC G06Q 30/0267; H04M 3/4878

(57) ABSTRACT

A process of providing services to a merchant to enable delivery of promotional materials performed by at least one or more first computing devices including at least tangible computing elements. The process includes the steps of receiving merchant account information for the merchant; generating a client identifier, a distributor authorization, an application programmer interface key, a certificate for a native part of a first computing device operating system that is configured to receive promotional materials, and a certificate for an application program of a second computing device operating system that is configured to receive promotional materials; receiving pass setup information from the merchant; and generating a tracking link for the merchant. When the tracking link is activated by a second computing device, the platform and operating system for the second computing device are determined and the promotional material are delivered accordingly.

### CROSS-REFERENCE TO RELATED APPLICATION

This application claims the benefit of U.S. Provisional Application No. 61/941,550 titled “MULTI-PLATFORM PROMOTIONS FOR MOBILE DEVICES” and filed 19 Feb. 2014 in the name of the same inventors as this non-provisional application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present disclosure generally relates to systems and methods of delivering promotional materials to users across multiple mobile computing device platforms.

### SUMMARY

Aspects of the subject technology include a process of providing services to a merchant to enable delivery of promotional materials performed by at least one or more first computing devices including at least tangible computing elements. The process includes the steps of receiving merchant account information for the merchant; generating a client identifier, a distributor authorization, an application programmer interface key, a certificate for a native part of a first computing device operating system that is configured to receive promotional materials, and a certificate for an application program of a second computing device operating system that is configured to receive promotional materials; receiving pass setup information from the merchant; and generating a tracking link for the merchant. When the tracking link is activated by a second computing device, the platform and operating system for the second computing device are determined and the promotional material are delivered over a network to a native part of the operating system or to an application program running on the second computing device based on the platform and operating system.

In some aspects, in a case that the platform and operating system of the second computing device comprises an iPhone® or iPad® and iOS®, the native part of the operating system comprises the iPhone® Passbook®, and the step of delivering delivers the promotional material to the iPhone® Passbook®. In a case that the platform and operating system of the second computing device comprises an Android® phone and Android® OS, the step of delivering delivers the promotional material to the application program.

The process may also include sending new or updated promotional material to the second computing device at the behest of the merchant. The tracking link comprises a shortened URL short enough to send via standard SMS text messaging.

The subject technology also includes systems configured to perform the above techniques.

This brief summary has been provided so that the nature of the invention may be understood quickly. Additional steps and/or different steps that those set forth in this summary may be used. A more complete understanding of the invention may be obtained by reference to the following description in connection with the attached drawings.

### BRIEF DESCRIPTION OF THE DRAWINGS

FIG. 1 illustrates a higher view of level data flow between participants for delivery of promotional materials to computing devices running different operating systems according to aspects of the subject technology.

FIG. 2 illustrates a lower level view of data flow between participants for delivery of promotional materials to computing devices running different operating systems according to aspects of the subject technology.

FIG. 3 illustrates various combinations of computing devices initiating requests for promotional materials and distribution of those materials according to aspects of the subject technology.

FIG. 4 shows a flow chart illustrating operations for providing services to a merchant to enable delivery of promotional materials to computing devices running different operating systems according to aspects of the subject technology.

FIG. 5 shows a flow chart illustrating processes for delivering promotional materials to computing devices running different operating systems according to aspects of the subject technology.

### DETAILED DESCRIPTION

U.S. Provisional Application No. 61/941,550 titled “MULTI-PLATFORM PROMOTIONS FOR MOBILE DEVICES” and filed 19 Feb. 2014 in the name of the same inventors as this non-provisional application is hereby incorporated by reference as if fully set forth herein.

Delivery of promotional materials such as discount offers to consumers on their mobile (and possibly other) computing devices is gaining increasing importance for merchants. However, delivery such materials can be a cumbersome process for merchants. One difficulty is that different types of mobile computing devices running different operating systems provide different mechanisms for delivery of such materials. For example, iOS® running on Apple's iPhone® devices has a native component called the Passbook® that accepts such promotional materials. On the other hand, Android® OS running on Android® (aka Droid) devices relies on application programs to accept such promotional materials. Google® provides an application program called the Google® Wallet® for this purpose. Typically, different delivery mechanisms are used to send the materials to consumers through these different mechanisms.

Furthermore, while the iPhone® platform currently hold a dominant smartphone market position, the competing Android® platform also has significant market penetration. Thus, enabling merchants to send promotional materials to both platforms should provide significant value to those merchants. However, delivery to the Google® Wallet® may not be attractive to some merchants. Once a consumer has installed the Wallet® application, promotional materials from many different merchants can be pushed to the consumer by Google®. By sending promotional materials to a consumer's Wallet® application, a merchant may trigger sending of competitor's promotional materials to that consumer.

Additional possible motivations for the processes described herein are set forth in the accompanying “passbee Company & Solution Overview” document. That document is incorporated into and forms a part of this provisional patent application. “Passbee” represents a media distributor as that term is used in this disclosure. The subject technology is not limited to the information set forth in the “passbee Company & Solution Overview” document.

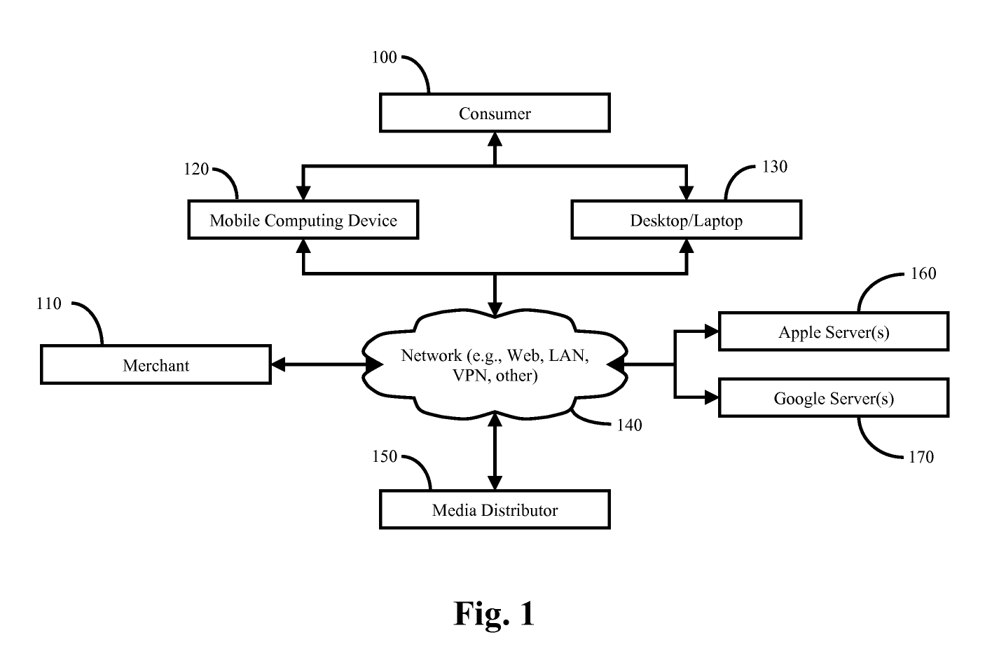

FIG. 1 illustrates a higher view of level data flow between participants for delivery of promotional materials to computing devices running different operating systems according to aspects of the subject technology. Consumer 100 in FIG. 1 desires to receive promotional materials (e.g., a discount offer) from merchant 110. The consumer is operating mobile computing device 120 such as a mobile phone or tablet computer and/or other computing device 130 such as a desktop or laptop computer. The consumer uses one of these computing devices to initiate a request for delivery of the promotional material to that computing device or to another computing device. The request is sent over network 140 to media distributor 150. Examples of network 140 includes but are not limited to a mobile phone network, the World Wide Web, the Internet, a Virtual Private Network (VPN), a Local Area Network (LAN), or some combination thereof.

In some aspects, the request is initiated by the consumer using the (preferably mobile) target computing device to which the promotional material is to be sent. The consumer may access a website, scan a QR code, scan a near field communication (NFC) tag, and/or access a wireless transmitter such as a CC2541_module Bluetooth® beacon with that computing device to initiate the request. In some aspects, this action delivers a tracking link in the form of a URL to the computing device.

In other aspects, the request is initiated by the consumer using a different computing device from the target device. For example, the consumer might access a webpage using a first computing device. The webpage may permit the user to enter identifying information for the second (preferably mobile) computing device. Examples of such identifying information include but are not limited to a phone number for the second computing device or an email address or Skype® identifier accessible by the second computing device. In some aspects, this action triggers delivery a tracking link in the form of a URL to the second computing device. In the case that the identifying information is a telephone number, delivery may be in the form of a text message containing the URL.

Different platforms and operating systems for mobile computing devices permit different sized messages to be received in a single text message. Thus, in order to permit a single URL to be used by the subject technology across different platforms and operating systems, the URL discussed above preferably is a shortened URL that is short enough to send via standard SMS text messaging. For example, Android® devices currently have a maximum SMS text message size of 160 characters, so the shortened URL preferably is no longer than 160 characters long.

Activating the URL triggers transmission of the request to media distributor for the promotional materials. The URL may be activated automatically in some cases, for example when a consumer initiates a request for promotion material using the (preferably mobile) target computing device to which the promotional material is to be sent. Alternatively, a consumer may have to take some additional action such as clicking on the URL, for example when the consumer initiates a request for promotional material using a different computing device from the target computing device.

In some aspects, activation of the URL also communicates information about the platform and operating system of the computing device to media distributor 150. The media distributor may use this information to send promotional materials for merchant 110 to the computing device in a configuration appropriate for that platform and operating system. The promotional material may be sent over network 140, possibly in cooperation with other computing devices such as servers 160 and 170.

For a first example, when the promotional material is to be sent to a Passbook® that is part of iOS® running on an Apple iPhone® or iPad® device, the promotional material may be automatically added to the Passbook®. Alternatively, media distributor 150 may serve a webpage to the iPhone®, iPad®, or any tablet/phablet device that permits the consumer to add the promotional material to their Passbook®.

For a second example, when the promotional material is to be sent to a Google® Wallet® application running under Android® OS on an Android® (aka Droid) device, the promotional material may be automatically added to the Wallet® application. Alternatively, media distributor 150 may serve a webpage to the Android® device that permits the consumer to add the promotional material to their Wallet® application.

For a third example, the media distributor may have developed an application for receipt of promotional material. An example of such an application is the Pocket for Android® devices discussed in the accompanying documents that form a part of this provisional application. In that case, the media distributor may interrogate the customer's device to see if such an application is installed. If the application is not installed, the media distributor may serve up a webpage that permits the consumer to install the application. That webpage or another webpage served up by the media distributor may also permit additional of the promotional material to that application.

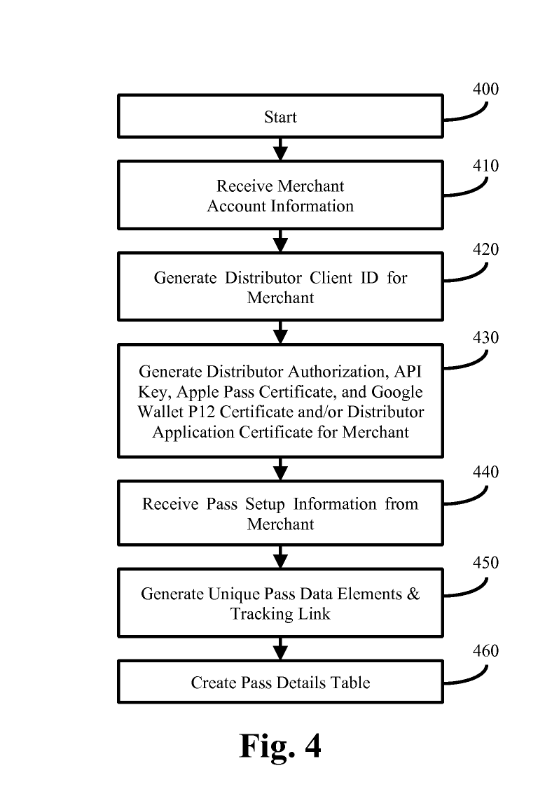

Merchant 110 is not necessarily involved in the initiation, request, and delivery data flows discussed above. Instead, according to some aspects of the subject technology, merchant 110 previously interacted with media distributor 150 to set up those processes, as discussed in more detail with respect to FIG. 4. Preferably, further interaction between merchant 110 and media distributor 150 permits delivery of updated and/or new promotional materials to computing devices on which the tracking link had been previously activated.

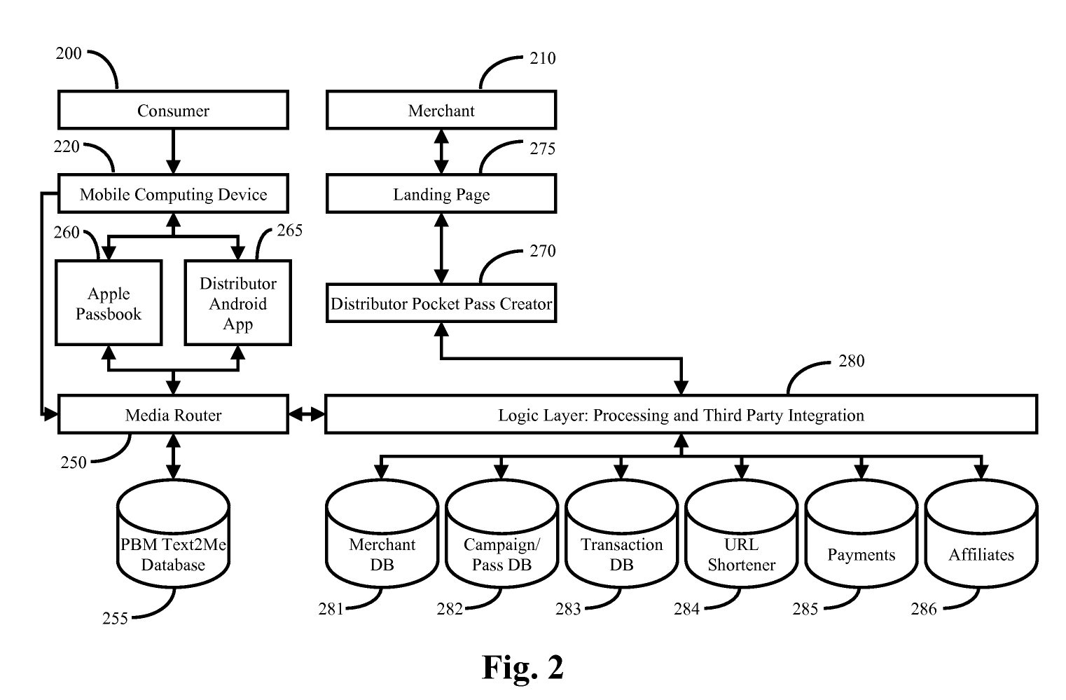

FIG. 2 illustrates a lower level view of data flow between participants for delivery of promotional materials to computing devices running different operating systems according to aspects of the subject technology. Consumer 200 corresponds to consumer 100 in FIG. 1. Likewise, merchant 210 corresponds to merchant 110 in FIG. 1, and mobile computing device 220 corresponds to mobile computing device 120 in FIG. 1. FIG. 2 does not include an element corresponding to other computing device 130 or network 140, but those elements may be present or implied.

Media router 250 handles receipt of requests, providing tracking links (referred to as Text2Me in FIG. 2) from database 255, and providing promotional materials to a user through a Passbook® 260, Android® application 265, or other application (e.g., Wallet®, not shown), for example as discussed above with respect to FIG. 1.

Merchant 210 interacts with distributor pass creator 270 through landing webpage 275 or some other interface to set up delivery of promotional materials to consumer 200. Logic layer 280 and various databases 281 to 286 may be used in these processes.

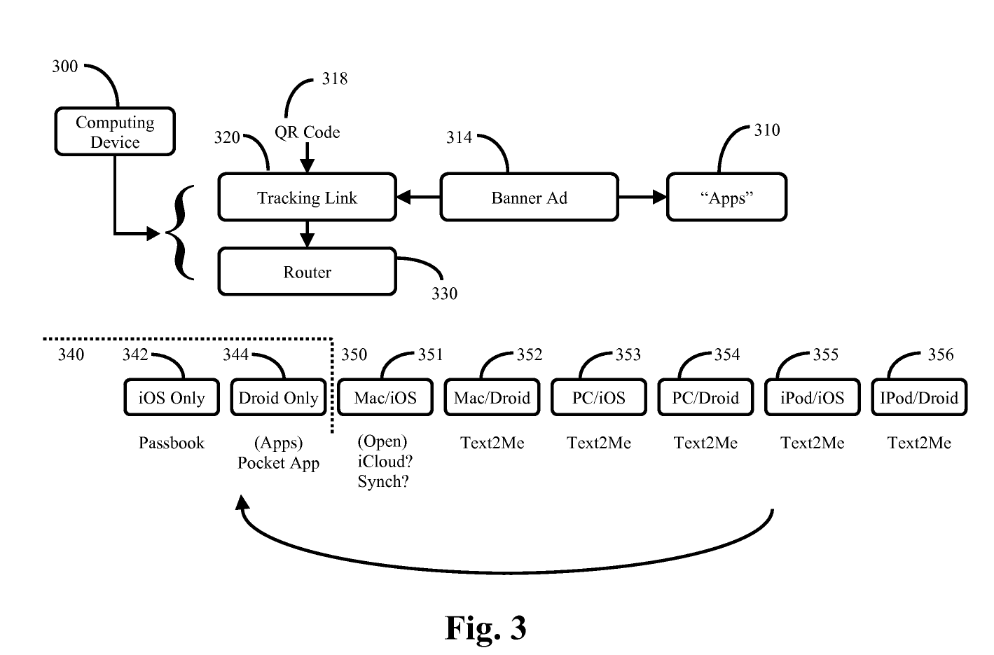

FIG. 3 illustrates various combinations of computing devices initiating requests for promotional materials and distribution of those materials according to aspects of the subject technology. Mobile computer device 300 may be used by a consumer to request promotional materials. Various apps 310 are installed on the computing device. One or more of these apps may generate a banner advertisement 314 that includes a clickable tracking link 320, for example a hyperlink including a shortened URL. Tracking link 320 also may be accessed by scanning a QR code 318 or through some other action (e.g., involving NFC, WiFi, Bluetooth, or other communications mediums). Once activated, the tracking link sends a request for delivery of the promotional materials from router 330 to computing device 300.

Area 340 illustrates two different platforms and operating systems for computing device 300 and associated channels for receiving promotional materials. iOS 342 is installed on an iPhone or iPod platform, and an Apple® Passbook® is running under that OS. Droid 344 is installed on an Adroid® platform, and a Pocket application (e.g., provided by a media distributor) is installed under that OS. Mobile computing device 300 may be or use other platforms, applications, and possibly applications for receipt of promotional materials.

Area 350 illustrates initiation of a request for promotional materials from different devices besides computing device 300. For example, a Mac running iOS is illustrated by box 351. The statement “(Open) iCloud? Synch” illustrates that the tracking link might be sent to computing device 300 via the iCloud or a synchronization operation. The various other platforms and operating systems shown by boxes 352 to 356 illustrates that the link may be sent via text (i.e., “Text2Me”), preferably in the form of a shortened URL that is short enough to fit within a standard SMS text message.

FIG. 4 shows a flow chart illustrating operations for providing services to a merchant to enable delivery of promotional materials to computing devices running different operating systems according to aspects of the subject technology. Flow starts in step 400. In step 410, a media distributor according to aspects of the subject technology receives merchant account information from a merchant, for example through a landing page as shown in FIG. 2. In response, a media distributor (or an allied entity) generates a distributor client identifier for the merchant in step 420. Likewise, a client identifier, a distributor authorization, an application programmer interface key, a certificate for a native part of a first computing device operating system that is configured to receive promotional materials (e.g., an Apple Passbook®), and a certificate for an application program of a second computing device operating system that is configured to receive promotional materials (i.e., a Google® Wallet® application and/or an application provided by the distributor) are generated for the merchant in step 430.

Pass (i.e., promotional material) setup information is received from the merchant in step 440. This pass setup information may include graphics, details of a promotional offer (e.g., a discount), or the like. In step 450, unique pass data elements are generated based on this setup information. A tracking link, preferably in the form of a shortened URL, is also generated in that step. In step 460, a pass detail table is created, for example for storing the relevant information in various databases such as shown in FIG. 3.

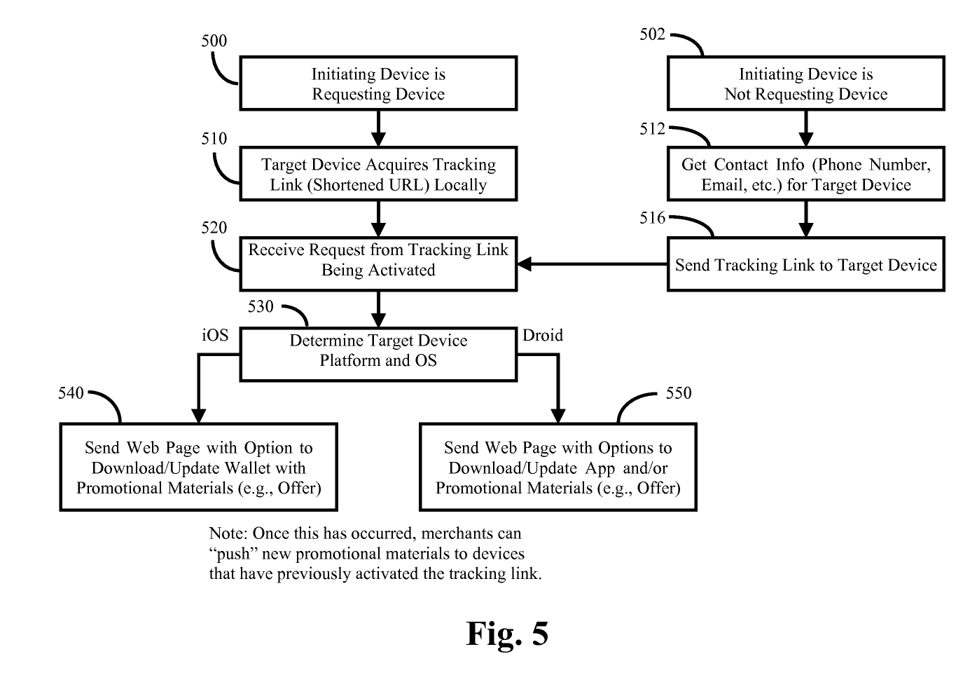

FIG. 5 shows a flow chart illustrating processes for delivering promotional materials to computing devices running different operating systems according to aspects of the subject technology. Flow begins in step 500 for the case that the computing device that initiates the request for promotional materials is also the target device that will receive the materials. In step 510, the computing device acquires a tracking link such as a shortened URL locally. For example, the computing device may be used to scan a QR code. The link may be acquired in other ways, some of which are discussed above.

In step 520, a media distributor receives a request for delivery of such materials to the computing device as a result of the tracking link being activated. This request preferably also communicates information about the platform and operating system of the computing device to the media distributor. This information is used in step 530 to determine the target device's platform and operating system. Based on that information, flow proceeds to the appropriate step 540 or 550 for delivery of the promotional materials to the target computing device.

Alternatively, the computing device that initiates the request for promotional materials may not be the target device that will receive the materials. In that case, flow start in step 502. Contact information for the target device is acquired in step 512. This information is used in step 516 to send a tracking link to the target device, for example in the form of a text (e.g., “Text2Me”), email, or some other form. Once the tracking link is activated on the target device, flow proceeds to step 520 and forward as discussed above.

Once the promotional materials have been delivered to the target device, a merchant (preferably via the media distributor) preferably can “push” new or updated promotional materials to devices that have previously activated the tracking link.

The subject technology may include variations of the foregoing processes. For example, the distributor of the promotional materials may provide merchants with the ability to use a toll-free phone number to receive calls. The distributor may then send a text message to the smart phones and/or other computing devices that call that number, with the text message including a tracking link that can be used to trigger delivery of promotional materials as discussed above. For another example, the system may be configured so that a consumer might text a response to a toll-free phone number to trigger delivery of such a tracking link.

The initiating computing device may be any computing device that includes at least tangible computing elements and that can communicate with other computing devices over a network. The communication may be via a mobile phone service, WiFi, the Web or Internet, or otherwise. Examples of such a computing device include but are not limited to a laptop computer, a desktop computer, a server, a part of a cloud computing system, a gaming counsel, or any other form of computing device.

The target computing device may be any mobile computing device that includes at least tangible computing elements and that can communicate with other computing devices over a network. The communication may be via a mobile phone service, WiFi, the Web or Internet, or otherwise. Examples of such a computing device include but are not limited to a smart phone, a tablet computer, a phablet computer, a gaming counsel, a portable electronic game, or a smart television. In some aspects, the target computing device does not necessarily have to be a mobile computing device. Likewise, the computing device that initiates the request for the promotional material may be a mobile computing device or any other form of computing device that includes tangible computing elements.

The computing device(s) used by the distributor to provide the promotional materials as discussed above may be any computing devices that include tangible computing elements and that can communicate with the target computing device over a network. The communication likewise may be via a mobile phone service, WiFi, the Web or Internet, or otherwise. Examples of such computing device(s) include but are not limited to a laptop computer, a desktop computer, a server, a part of a cloud computing system, a gaming counsel, or any other form of computing device.

The computing devices preferably include or accesses storage for instructions used to perform processes such as those discussed above. The computing devices according to aspects of the subject technology may perform processes such as those described above either alone or in conjunction with one or more other computing devices. For example, data may be stored on another computing device that communicates with the computing device that performs a particular process on the data. For another example, processes may be performed by multiple computing devices working together.

The invention is in no way limited to the specifics of any particular embodiments and examples disclosed herein. For example, the terms “aspect,” “example,” “preferably,” “alternatively” and the like denote features that may be preferable but not essential to include in some embodiments of the invention. In addition, details illustrated or disclosed with respect to any one aspect of the invention may be used with other aspects of the invention. Additional elements and/or steps may be added to various aspects of the invention and/or some disclosed elements and/or steps may be subtracted from various aspects of the invention without departing from the scope of the invention. Singular elements/steps imply plural elements/steps and vice versa. Some steps may be performed serially, in parallel, in a pipelined manner, or in different orders than disclosed herein. Many other variations are possible which remain within the content, scope and spirit of the invention, and these variations would become clear to those skilled in the art after perusal of this application.

1. A method of providing services to a merchant to enable delivery of promotional materials performed by at least one or more first computing devices including at least tangible computing elements, comprising the steps of:
receiving merchant account information for the merchant;
generating a client identifier, a distributor authorization, an application programmer interface key, a certificate for a native part of a first computing device operating system that is configured to receive promotional materials, and a certificate for an application program of a second computing device operating system that is configured to receive promotional materials;
receiving pass setup information from the merchant; and
generating a tracking link for the merchant;
wherein when the tracking link is activated by a second computing device, the platform and operating system for the second computing device are determined and the promotional material are delivered over a network to a native part of the operating system or to an application program running on the second computing device based on the platform and operating system.

2. A method as in claim 1, wherein the step of delivering delivers the promotional material to the native part of the operating system.

3. A method as in claim 1, wherein the step of delivering delivers the promotional material to the application program.

4. A method as in claim 1, further comprising sending new or updated promotional material to the second computing device at the behest of the merchant.

5. A method as in claim 1, wherein the tracking link comprises a shortened URL short enough to send via standard SMS text messaging.

6. A system that provides services to a merchant to enable delivery of promotional materials, comprising:
at least one or more first computing devices including at least tangible computing elements
at least one connection to a network;
wherein the first computing devices perform steps comprising:
receiving merchant account information for the merchant;
generating a client identifier, a distributor authorization, an application programmer interface key, a certificate for a native part of a first computing device operating system that is configured to receive promotional materials, and a certificate for an application program of a second computing device operating system that is configured to receive promotional materials;
receiving pass setup information from the merchant; and
generating a tracking link for the merchant;
wherein when the tracking link is activated by a second computing device, the platform and operating system for the second computing device are determined and the promotional material are delivered over the network to a native part of the operating system or to an application program running on the second computing device based on the platform and operating system.

7. A method as in claim 6, wherein the step of delivering delivers the promotional material to the native part of the operating system.

8. A method as in claim 6, wherein the step of delivering delivers the promotional material to the application program.

9. A method as in claim 6, further comprising sending new or updated promotional material to the second computing device at the behest of the merchant.

10. A method as in claim 6, wherein the tracking link comprises a shortened URL short enough to send via standard SMS text messaging.
